(19) United States
(12) Patent Application Publication
(10) Pub. No.: US 2007/0195284 A1
(43) Pub. Date: Aug. 23, 2007

(54) Projection optical system and projection display device employing the same

(75) Inventor: Osamu Konuma, Yokohama (JP)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/654,620

(22) Filed: Jan. 18, 2007

(30) Foreign Application Priority Data
Feb. 20, 2006 (JP) 2006-042394
Aug. 30, 2006 (KR) 10-2006-0082936

(51) Int. Cl. G03B 21/14

(52) U.S. Cl. 353/69

(57) ABSTRACT

A projection optical system and a projection display device employing the projection optical system are provided. The projection optical system includes a display device displaying an image to be projected onto an image display region, and first and second optical systems sequentially disposed along an optical path from a screen to the display device. When the optical axis of the first optical system is taken as a reference axis, the image display region of the display device is disposed with parallel eccentricity to the reference axis, and the second optical system is disposed eccentrically to the reference axis. Thus, an image displayed on the image display region is enlarged and projected on a position that is eccentric with reference to the reference axis. The projection display device includes an illuminating unit radiating light for forming an image to be projected and the projection optical system,

### CROSS-REFERENCE TO RELATED PATENT APPLICATION

This application claims the benefit of Japanese Patent Application No. 2006-042394, filed on Feb. 20, 2006 in the Japanese Intellectual Property Office and Korean Patent Application No. 10-2006-0082936, filed on Aug. 30, 2006, in the Korean Intellectual Property Office, the entire disclosures of both of which are hereby incorporated by reference.

### BACKGROUND OF THE INVENTION

1. Field of the Invention

The present invention relates to a projection optical system and a projection display device. More particularly, the present invention relates to an offset projection optical system that projects an image at a position offset from an optical axis and a projection display device including the optical projection system.

2. Description of the Related Art

Conventional projection display devices obliquely project images displayed in a display device, such as a projector, onto a screen arranged on a vertical surface, such as a wall. For example, projection display devices are installed on a table or on a ceiling and project images obliquely in a direction above or below the installation position. Because the optical axis of a projection optical system is set at an angle toward the screen, a surface of the screen crosses obliquely with the optical axis of the projection optical system. Thus projected images are distorted, thereby deteriorating the image quality.

Accordingly, the optical axis of the projection optical system can be arranged almost horizontally so that the projection optical system projects images at an angle to an upper region of an effective image region of the projection optical system, which is called offset projection.

For example, as shown in FIG. 9 of Japanese Patent Publication No. Hei 11-249069, a display optical system (projection display device) in which a digital micromirror device (DMD) is arranged with parallel eccentricity such that a edge portion of a display region of the DMD corresponds to the optical axis of the projection optical system, and projects images to a half of a side of the projection region of the projection optical system, for example, an upper portion of the projection region.

Also, although not related to the offset projection in the effective image region, there is a projection technique that can be used to project images such that the optical axis of the projection optical system and the center of the image display region correspond to each other by correcting the images the display device, which is disposed with parallel eccentricity to the optical axis of the projection optical system.

For example, as shown in FIGS. 1, 2, 5, 6, 9 and 10 of Japanese Patent Laid-Open No. 2000-39585, a projection display device has an eccentric optical device that is disposed highly eccentrically disposed between a reflective display device and the projection display device. The center of the image display region of the reflective display device that is disposed with inclined eccentricity to the optical axis of the projection system corresponds to the optical axis of the projection system.

However, conventional projection optical systems and projection display devices as described above have the following problems.

In Japanese Patent Publication No. Hei 11-249069, for example, because the screen and an image surface of the projection optical system can be disposed parallel to each other distortion of images due to the rotation of the image surface around the screen is not generated even when the images are projected in an above direction. However, the projection optical system must project the entire image display region onto a portion, for example, an upper portion of the effective image display region. The projection optical system can only be used at a narrow range of viewing angles, including a high viewing angle unit with improper aberrations among projection viewing angles. Thus, the effective image display region of the projection optical system should be extended or the number of the optical elements should be increased to reduce aberrations. As a result, projection optical systems become bulky and complicated, and increase the price of the projection optical system.

It is possible to move the projection region of the display device that is disposed eccentrically by arranging an eccentrically disposed optical device between a display device and the projection optical system based on Japanese Patent Laid-Open No. 2000-39585. However, Japanese Patent Laid-Open No. 2000-39585 relates to achieving a decrease in aberrations by disposing an optical device eccentrically at a position where the center of the image projection region corresponds to the center of the projection optical system. Accordingly, this has nothing to do with offset projection by disposing the display device with parallel eccentricity. That is, Japanese Patent Laid-Open No. 2000-39585 cannot be applied to the offset projection optical system.

To apply offset projection, a side of the display region in the offset direction should be doubled and only a half of the entire region with decreased aberrations should be used, and in this case, it is obvious that the aberrations are not decreased to the same degree as in Japanese Patent Laid-Open No. 2000-39585.

Accordingly, a need exists for a projection display device including an improved projection optical system that has offset projection and that improves image quality.

### SUMMARY OF THE INVENTION

The present invention provides a projection optical system that projects high quality images by reducing aberrations with a simple structure during offset projection and a projection display device employing the projection optical system.

According to an exemplary embodiment of the present invention, a projection optical system comprises a display device displaying an image to be projected onto an image display region, and first and second optical systems sequentially disposed along an optical path from a screen to the display device. When the optical axis of the first optical system is a reference axis, the image display region of the display device is disposed with parallel eccentricity to the reference axis. The second optical system is disposed eccentrically to the reference axis, so that an image displayed on the image display region is enlarged and projected in a position that is eccentric with reference to the reference axis.

According to another exemplary embodiment of the present invention, a projection display device comprises an illuminating unit illuminating light to form an image to be projected; and the projection optical system.

According to an exemplary embodiment of the present invention, the second optical system near the display device is disposed with eccentricity around the optical axis of the first optical system near the screen. Thus, the direction of the beams of diffused light proceeding with eccentricity in the image display region disposed with parallel eccentricity around the reference axis may be corrected according to the amount of eccentricity of the second optical system.

The image display region of the display device is disposed with parallel eccentricity around the reference axis, that is, for offset projection, the beam transmits a higher portion of the image height of the projection optical system. Thus, aberrations are likely to increase, and because the image display region and the reference axis do not correspond to each other, asymmetric aberrations are generated in the projected image.

When the second optical system is disposed with parallel eccentricity, aberrations with respect to an axis shift component, such as distortion, are generated in the direction of the parallel eccentricity. Accordingly, distortion is cancelled and the size and symmetry of the distortion may be improved by disposing the second optical system with parallel eccentricity in the same direction as the parallel eccentricity with respect to the reference axis of the image display region. Additionally, when the second optical system is disposed with inclined eccentricity around the circumference proceeding respectively in the direction of the parallel eccentricity of the reference axis and of the image display region, aberrations with respect to an axis shift component, such as distortion, are generated, and thus distortion may be cancelled by disposing the second optical system with inclined eccentricity, thereby improving the size and symmetry of the distortion.

Consequently, even when aberrations, such as distortion, remain in the higher portion of the image height of the first optical system, the aberrations may be corrected in the range where an image is projected.

Additionally, the image projection device according to an exemplary embodiment of the present invention uses the projection optical system to enlarge an image of the image display region.

The projection display device according to an exemplary embodiment of the present invention uses the projection optical system and thus has the same effect as the projection optical system.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a front view of a projection display device according to an exemplary embodiment of the present invention;

FIG. 2 is a cross-sectional view of a projection optical system used in the projection display device of FIG. 1, including an optical axis;

FIG. 3 is a front view of a projection display device according to another exemplary embodiment of the present invention;

FIG. 4 is a cross-sectional view of a projecting optical system used in the projection display device of FIG. 3, including an optical axis;

FIG. 5 is a cross-sectional view of a projection optical system of FIG. 1 and optical paths of the projection optical system according to first through fourth variation examples, including the optical axis;

FIG. 6 is a vector diagram illustrating distortion of a comparative example;

FIGS. 7A and 7B are vector diagrams illustrating distortions of the first and second variation examples;

FIGS. 8A and 8B are vector diagrams illustrating distortions of the third and fourth variation examples; and

FIG. 9 is a schematic view illustrating the calculation positions of curvature of image surfaces of each variation example and of the comparative example.

Throughout the drawings, like reference numerals will be understood to refer to like parts, components and structures.

### DETAILED DESCRIPTION OF EXEMPLARY EMBODIMENTS

Exemplary embodiments of the present invention are described more fully with reference to the accompanying drawingscommon descriptions are omitted of similar or corresponding members between drawings.

Hereinafter, a projection optical system and a projection display device according to an exemplary embodiment of the present invention is described.

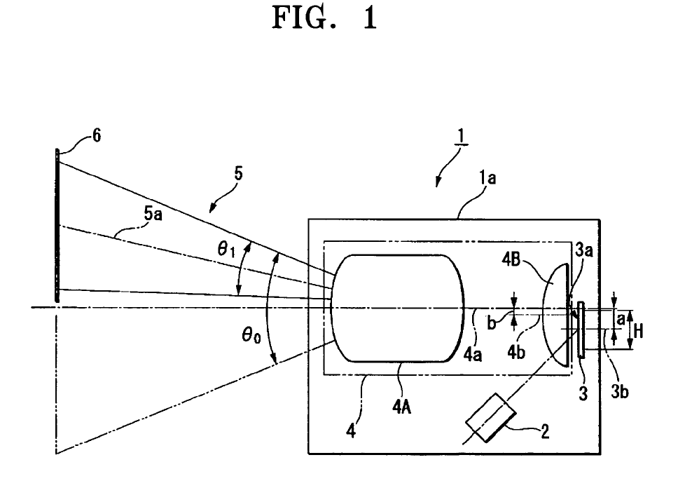

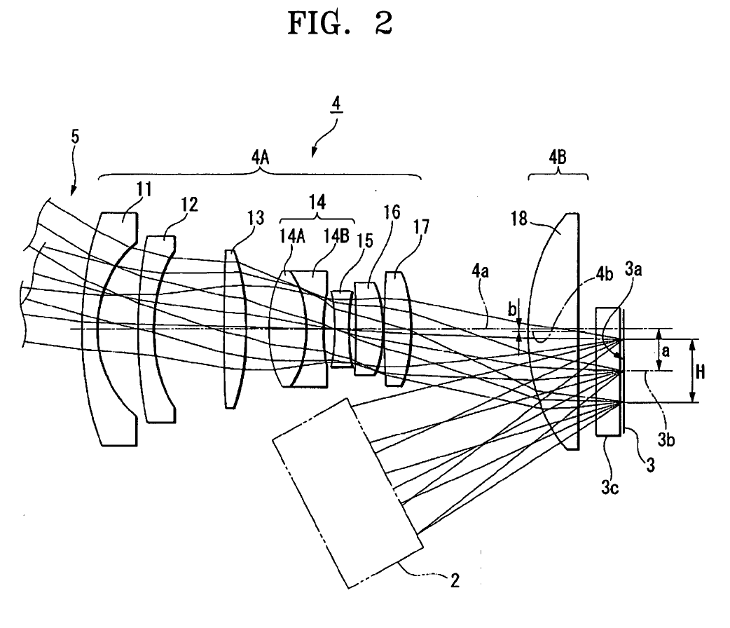

FIG. 1 is a front view illustrating a projection display device according to an exemplary embodiment of the present invention. FIG. 2 is a cross-sectional view of a projection optical system used in the projection display device of FIG. 1, including an optical axis.

Because the drawings are schematic views, the measurements or shapes may be exaggerated and may not indicate exact positions, which applies throughout the specification hereinafter.

The projection display device 1 in an exemplary embodiment of the present invention includes, as illustrated in FIG. 1, an illuminating unit 2, a reflective display device 3, and a projection optical system 4 that are disposed in a case l a. Furthermore, though not illustrated in the drawing, a power supplying unit driving the projection display device 1 and a device controlling unit for controlling the projection display device I are included and are connected to the illuminating unit 2 and the reflective display device 3.

In the exemplary embodiment of FIG. 1, the case la of the projection display device 1 is arranged horizontally so that a projected beam 5 is inclined upwardly from an arrangement surface and thus an image is projected on a screen 6 installed substantially perpendicularly to the arrangement surface. However, such arrangement and projection directions are not limited to such a configuration and any suitable configuration may be used. For example, the surface of the screen 6 may be inclined or the projection direction may be inclined downwardly.

The illuminating unit 2 is a light source radiating illumination light toward an image display region of the reflective display device 3. In the exemplary embodiment of FIG. 1, at least three colors of light, red (R), green (G), and blue (B), and beams having wavelengths corresponding to white light may be time-divided and sequentially irradiated to display full color images. For example, light sources with R, G, and B wavelengths that may be independently driven are provided and synthesized on the same optical path. Also, a white light source may be provided and driving filters for R, G, and B may be installed on the optical path.

Light irradiated from the illuminating unit 2 may be emitted at an appropriate angle so that light reflected by the reflective display device 3 is incident on the projection optical system 4. However, in the exemplary embodiment of FIG. 1, light from the illuminating unit 2 is irradiated slantingly from below the screen 6 to the above direction and passes through a second optical system 4B, which will be described later, and is incident on the reflective display device 3. Additionally, a mirror or a prism may be included to fold the optical path depending on the form of the layout of the projection display device 1.

The reflective display device 3 spatially modulates illumination light of wavelengths irradiated according to radiation timing from the illuminating unit 2 according to image signals, and the images that are color-separated are displayed on an image display region 3a that is covered by a cover glass 3c (see FIG. 2).

The image display region 3a is not illustrated in detail, but is formed of a plurality of spatial modulation elements each corresponding to a pixel unit of the image signals arranged on the display plane in a lattice. In the exemplary embodiment of FIGS. 1 and 2, the image display region 3a is formed of a W×H rectangle, wherein W is a long side and H is a short side. A central normal 3b denotes the normal of the display plane at the center of the image display region 3a.

The image display region 3a of the reflective display device 3 is disposed so that the central normal 3b is disposed eccentrically by a distance a and parallel to the optical axis 4a of a first optical system 4A, which will be described later. The image display region 3a is disposed in a direction substantially opposite to the screen on an image surface of the projection optical system 4.

The ratio of the degree of eccentricity to half of the shorter side of the image display region 3a is expressed as an axis offset Δh, that is,

Δh=a/(H/2) (1)

The axis offset may be set according to offset projection conditions, and in the exemplary embodiment of FIGS. 1 and 2, it is in the following range:

0<Δh≦2.0 (2),

preferably, 1.0≦Δh≦1.5 (3)

The reflective display device 3 may be a fine mirror array, such as a digital micromirror device (DMD) or a reflective liquid crystal on silicon (LCOS).

The projection optical system 4 is an optical system enlarging the image displayed on the image display region 3a of the reflective display device 3 and projecting the image onto the screen 6 and operates for both the image display region 3a and the screen 6.

The projection optical system 4 is formed of a second optical system 4B and a first optical system 4A, mentioned in order on the optical path from the reflective display device 3 to the screen 6.

The first optical system 4A is an extension projection system having a view angle θ₀. In the exemplary embodiment of FIGS. 1 and 2, the first optical system 4A includes a first lens 11, a second lens 12, a third lens 13, a fourth lens 14, a fifth lens 15, a sixth lens 16, and a seventh lens 17 arranged on an optical axis 4a. The optical axis 4a is arranged substantially perpendicularly to the arrangement surface of the projection display device 1.

Each lens may have a shape and power satisfying a function as an extension projection system, and an example is as follows.

The first lens 11 and the second lens 12 are preferably concave meniscus lenses that are convex toward the screen 6.

The third lens 13 is preferably a biconvex lens.

The fourth lens 14 is preferably a junction lens formed of a biconvex lens 14A and a biconcave lens 14B arranged in sequence from the screen.

The fifth lens 15 is preferably a biconcave lens.

The sixth lens 16 is preferably a convex meniscus lens that is convex towards the image display region 3a.

The seventh lens 17 is preferably a biconvex lens.

The projection optical system thus has a configuration having negative (−), negative (−), positive (+), positive (+), negative (−), positive (+), and positive (+) powers from the screen to the image display region 3a.

The second optical system 4B is an optical system having positive power for adjusting the optical path and focusing of light between the first optical system 4A and the reflective display device 3 and is disposed eccentrically to the optical axis 4a. In the exemplary embodiment of FIGS. 1 and 2, the second optical system 4B is disposed with substantially parallel eccentricity to the optical axis 4a by a distance b in the same direction as the eccentricity of the reflective display device 3. Reference numeral 4b denotes the optical axis of the second optical system 4B.

Because the size and direction of the degree of the parallel eccentricity varies according to the configuration of the projection optical system 4, light beams are tracked so that distortion amount or symmetry balance at a projection position where the image display region 3a is enlarged and projected is set to be within an allowable range.

Generally, the degree of the parallel eccentricity of the second optical system 4B, related to the distance b, may be smaller than the degree of parallel eccentricity of the reflective display device 3, related to the distance a, to obtain sufficient effect. Thus when the second optical system 4B is disposed eccentrically the image projection region on the screen 6 does not change very much and is kept in an offset projection state.

The second optical system 4B is formed of only a view lens 18, which is preferably a biconvex lens, wherein the side facing the image display region 3a is almost planar.

The view lens 18 faces the image display region 3a. The cover glass 3c, which has no refractive power, is disposed therebetween. Thus, the second optical system 4B is disposed closest to the reflective display device 3 as an optical device having refractive power.

The second optical system 4B in the exemplary embodiment of FIGS. 1 and 2 of the present invention is provided on the optical path between the illuminating unit 2 and the reflective display device 3, and collimates light from the illuminating unit 2 onto the image display region 3a.

Next, the operation of the image projection device 1 is described referring to the optical function of the projection optical system 4.

Illumination light of a predetermined wavelength emitted from the illuminating unit 2 according to predetermined timing, passes through the second optical system 4B and is collimated as illustrated in FIG. 2, and then passes through the cover glass 3c and is incident slantingly to the central normal 3b of the image display region 3a.

Each spatial modulation element on the image display region 3a is driven according to image signals corresponding to predetermined wavelengths and timing in an on state in which illumination light is reflected to be incident on the projection optical system 4 and in an off state in which the illumination light is not reflected to not be incident on the projection optical system 4.

Accordingly, an image is displayed on the image display region 3a by light reflected by the spatial modulation elements in an on state. The reflected light passes through the cover glass 3c and is incident on the second optical system 4B and is refracted by the second optical system 4B to be collimated and to pass toward the first optical system 4A.

Here, because the view lens 18 is disposed with parallel eccentricity to the optical axis by a distance b, the direction of refraction varies according to the direction of eccentricity compared to when the view lens 18 is coaxial with the optical axis 4a. Accordingly, the incident position and incident angle of light to the first optical system 4A vary according to the power and focal distance of the view lens 18.

Because the view lens 18 is an optical device having power for making reflected light of the reflective display device 3 initially pass through in the optical projection system 4, light having relatively small luminous diameter passes through the view lens 18. Accordingly, refraction by the view lens 18 affects aberrations with respect to geometrical disagreement of the image forming position on the screen, such as distortion or image surface curvature, rather than imaging aberrations, such as spherical aberration. For instance, parallel eccentricity affects distortion and inclined eccentricity affects image surface curvature.

Also, when the parallel eccentricity, related to the distance b, is set appropriately, distortion may be reduced or symmetry may be improved by using a smaller eccentricity compared to the parallel eccentricity of the reflective display device 3.

Due to the above described eccentricity, aberrations on the optical path toward the projection region, which is not included to the image projection region on the screen 6, may increase. However, because an image is not projected onto such region in an offset projection, such problems do not occur. In the exemplary embodiment of FIGS. 1 and 2, the aberration distribution in all the viewing angles of the projection optical system 4 is modified to improve aberrations in the image projection region of the screen 6.

Light emitted from the second optical system 4B is incident on the first optical system 4A and passes through the seventh lens 17, the sixth lens 16, the fifth lens 15, the fourth lens 14, the third lens 13, the second lens 12, and the first lens 11, and is refracted by each of the lenses, increasing a viewing angle 01, thereby being imaged on the screen 6. The viewing angle θ₁ is an angle taken around a central projection axis 5a that is an axis that is extended inclining upwardly from the optical axis 4a. The viewing angle θ₁ relates to the magnification of the projection optical system 4 as illustrated in FIG. 1.

Thus, an image displayed on the image display region 3a is enlarged and projected on the screen 6. The projection position on the screen 6 is determined approximately by the magnification of the projection optical system 4 and the degree of the parallel eccentricity related to distance a of the central normal 3b of the image display region 3a, and the distortion at the projection position is improved by the degree of the parallel eccentricity related to distance b of the second optical system 4B. As a result, a high quality image may be projected offset by the projection display device 1.

The exemplary embodiment of FIGS. 1 and 2 may be modified in various forms. That is, the eccentricity of the optical device may be changed in various ways from the above described configuration.

For example, the second optical system 4B may be disposed with inclined eccentricity by rotating the second optical system 4B around an axis that is perpendicular to both the optical axis 4a and the parallel eccentricity direction of the reflective display device 3 instead of the second optical system 4B being located with parallel eccentricity. Thus, distortion due to the parallel eccentricity of the reflective display device 3 may be improved by the rotation direction.

Another modification that may be made to the exemplary embodiment of FIGS. 1 and 2 involves some of the optical elements of the first optical system 4A being disposed with parallel eccentricity in addition to the eccentricity of the second optical system 4B. The combination of parallel eccentricity of another optical device, which has a different influence on distortion, and so forth, allows aberrations to be corrected more specifically. Also, because an optimum eccentricity amount is given between a portion of the optical device of the first optical system 4A and the second optical system 4B, the influence on other aberrations may be reduced.

Additionally, the optical axis 4a of the first optical system 4A, which is the reference axis of the projection optical system 4, denotes the optical axis of the first optical system 4A excluding some elements of the first optical system 4A that has been disposed eccentrically.

Another modification that may be made to the exemplary embodiment of FIGS. 1 and 2 is increasing the inclined eccentricity by rotating the reflective display device 3, the second optical system 4B, or some optical elements of the first optical system 4A around an axis that is perpendicular to both the optical axis 4a and the parallel eccentricity direction of the reflective display device 3.

The inclined eccentricity usually affects image surface curvature as described above such that disagreement of images at the image surface may be improved and high quality offset projection is enabled.

The direction of the inclined eccentricity and the degree of the eccentricity may be set appropriately in consideration of influences on other aberrations depending on the configuration of the projection optical system 4. For example, distortion is decreased by parallel eccentricity but image surface curvature may deteriorate. Thus, the degree of the inclined eccentricity may be increased to reduce the distortion and the image surface curvature.

Hereinafter, a projection optical system and a projection display device according to another exemplary embodiment of the present invention is described.

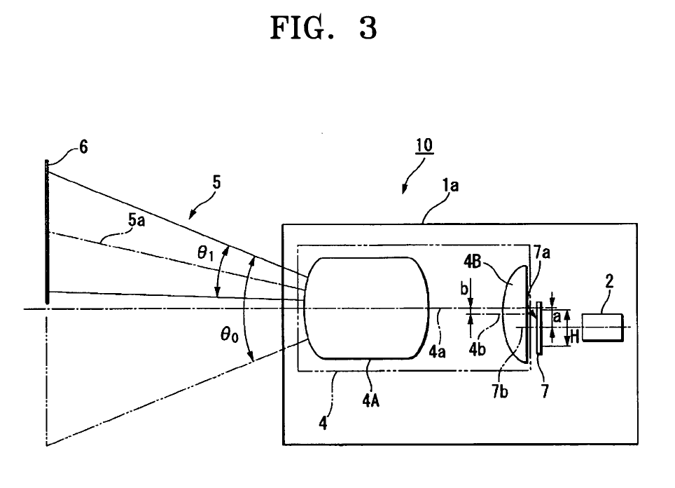

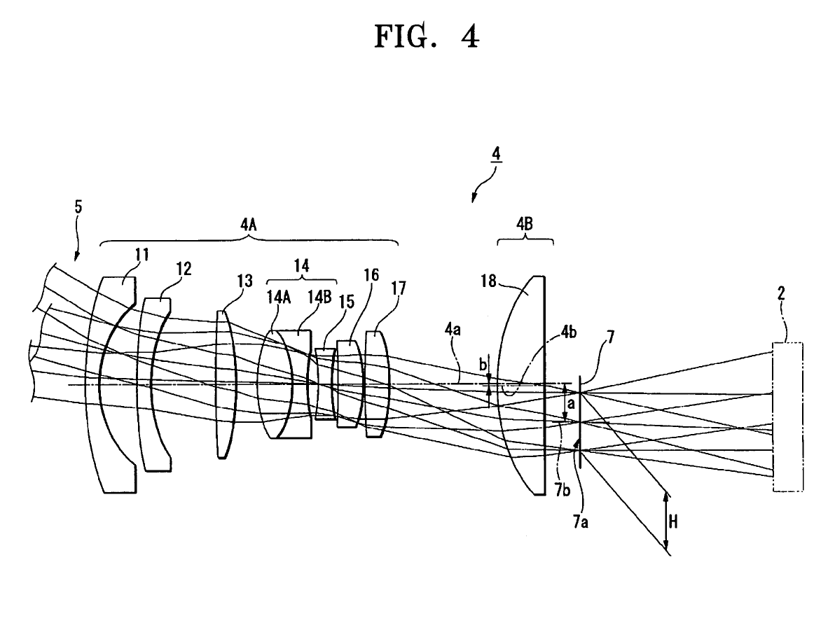

FIG. 3 is a front view illustrating a projection display device according to another exemplary embodiment of the present invention. FIG. 4 is a cross-sectional view illustrating a projecting optical system used in the projection display device of FIG. 3, including an optical axis.

The projection display device 10 in the exemplary embodiment of FIGS. 3 and 4 of the present invention includes a transmissive display device 7 instead of the reflective display device 3 of the projection display device 1 of FIG. 1, and the illumination direction of the illuminating unit 2 is changed to a rear surface of the transmissive display device 7. Hereinafter, the projection display device 10 of the exemplary embodiment of FIGS. 3 and 4 of the present invention is described with reference to main differences from the exemplary embodiment of FIGS. 1 and 2.

The transmissive display device 7 spatially modulates illumination light of predetermined wavelength irradiated by the illuminating unit 2 according to radiation timing from the rear surface of the display surface according to image signals and displays a color-separated image on an image display region 7a. The transmissive display device 7 may be, for example, a liquid crystal display (LCD).

In the exemplary embodiment of FIGS. 3 and 4, the transmissive display device 7 is formed as a single panel type for convenience of explanation. A conventional transmissive display device is formed as a three panel type, including transmissive spatial modulation devices for R, G, B lights, such as LCDs, and includes a color combining unit to combine light that has passed through each of the transmissive spatial modulation devices. The color combining unit is required to be disposed between the projection optical system 4 and the transmissive display device 7. However, the color combining unit is omitted in the present description. Additionally, display surfaces of the three transmissive spatial modulation devices form an image display region arranged at optically equivalent positions by the color combining unit.

The image display region 7a is not illustrated in detail, and is formed of a plurality of spatial modulation elements each corresponding to a pixel unit of image signals, which are arranged on the display plane in a lattice. In the exemplary embodiment of FIGS. 3 and 4, the image display region 7a is provided as a W×H rectangle, wherein W refers to a long side and H refers to a short side. A central normal 7b denotes the normal of the display plane at the center of the image display region 7a.

The image display region 7a of the transmissive display device 7 is arranged in the same position as the reflective display device 3 to the projection optical system 4 in the exemplary embodiment of FIGS. 1 and 2. That is, the image display region 7a is disposed with parallel eccentricity to the optical axis 4a of the first optical system 4A by a distance a, and opposite to the screen on an image surface of the projection optical system 4.

Also, the axis offset Δh is defined as in the exemplary embodiment of FIGS. 1 and 2.

As described above, the projection display device 10 in the exemplary embodiment of FIGS. 3 and 4 of the present invention uses the transmissive display device 7 instead of the reflective display device 3.

Accordingly, illumination light may be irradiated from a rear surface of the transmissive display device 2. Thus, the illuminating unit 2 is easily arranged to not interfere with the projection optical system 4, thereby improving the degree of freedom of the layout of the device.

Also, the projection optical system in the current exemplary embodiment of FIGS. 3 and 4 has the same effect as the previous exemplary embodiment of FIGS. 1 and 2 regarding the optical path and the optical function from the display device to the screen 6 because the only difference of the current exemplary embodiment from the previous exemplary embodiment is that illumination light from the illuminating unit 2 does not pass through the second optical system 4B but is induced to the display device in the current exemplary embodiment.

Accordingly, an image displayed on the image display region 7a is enlarged and projected on the screen 6 by the projection optical system 4. The projection position on the screen 6 is determined approximately by the degree of parallel eccentricity related to the distance a of the central normal 7b of the image display surface 7a. Distortion at the projection position may be reduced by the degree of parallel eccentricity related to the distance b of the second optical system 4B. Accordingly, high quality images may be projected offset by the projection display device 10.

The projection display device of the exemplary embodiment of FIGS. 3 and 4 of the present invention may also be modified in various ways as described with reference to the previous exemplary embodiment of FIGS. 1 and 2.

Additionally, in the previous exemplary embodiment of using the reflective display device 3, illumination light from the illuminating unit 2 passes through the second optical system 4B to be induced to the image display region 3a, but it is not limited thereto. For example, the controlling degree of the illumination light in the illuminating unit 2 may be set appropriately, and the illumination light may be irradiated to the image display region 3a without passing through the second optical system 4B.

The second optical system 4B described above is formed as a single lens. However, the second optical system 4B may be formed as a group of lenses.

The display device described above is formed of a spatial modulation device or a plurality of spatial modulation devices and a color combining unit, and the image display surface of the spatial modulation device becomes the image display region. However, the image display region may be different from the image display surface of the spatial modulation device, that is, an image on the image display surface of the spatial modulation device may be formed on another display surface.

A front projection type projection display device in which an image is projected onto a screen that is installed outside the projection display device has been described above. However, a rear projection type projection display device in which an image is projected from the inside of the device onto a transmissive screen that is formed on the outer circumference portion of the projection display device may also be used.

The axis offset direction of the display device is described to be in the direction of a short side of the image display region 3a, but is not limited thereto. For example, the same effect may be achieved by changing the offset direction of the display device in the axis offset direction when the axis offset direction is of a long side of the image display region 3a or is in another direction.

The display device, the second optical system, and some optical elements of the first optical system are described to have a constant eccentricity, but may also be adjusted manually or automatically upon demands by installing an eccentricity variation unit.

Components described in each exemplary embodiment and variation examples thereof may be realized by being combined within the spirit and scope of the present invention.

Hereinafter, projection optical systems according to first through fourth variations of the exemplary embodiment of FIGS. 1 and 2, and a comparative example of a conventional art system are described.

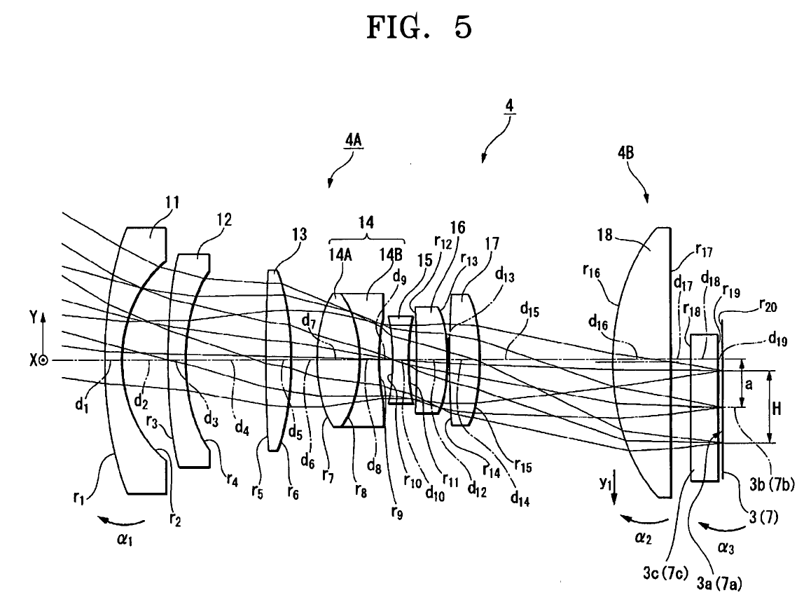

FIG. 5 is a cross-sectional view illustrating a projection optical system of FIG. 1 and optical paths of the projection optical system according to first through fourth variation examples, including the optical axis. In each variation example, some optical devices are disposed eccentrically, and because the degree of eccentricity of each optical device is small, the variation examples are described using one drawing.

Hereinafter, the parallel eccentric direction of the screen 6 (upper direction of the drawing in FIGS. 1, 2, and 5), which is perpendicular to the optical axis 4a, is set as a positive direction of the y-axis. A direction perpendicular to the y-axis, that is, a front direction on a page is set as a positive direction of an x-axis. The image display region 3a is a rectangle having a width W in the x-axis direction and a height H in the y-axis direction, and the parallel eccentricity b in FIG. 1 is in a negative direction of the y-axis.

In the first variation example, the second optical system 4B is disposed with parallel eccentricity in a negative direction of the y-axis by 0.3 mm. The first variation example is an example of the exemplary embodiment with reference to FIG. 1.

In the second variation example, the image display region (image surface) 3a is disposed with inclined eccentricity such that the image display region is rotated by 6 minutes in a clockwise direction on the page with the cover glass 3c from the first variation example.

In the third variation example, the second optical system 4B is disposed with inclined eccentricity such that the second optical system 4B is rotated by 1.5 degrees (1 degree and 30 minutes) in a clockwise direction on the page. In the fourth variation example, the first lens 11 of the first optical system 4A of the third variation example is disposed with inclined eccentricity such that the first lens 11 of the first optical system 4A is rotated by 33 minutes in a clockwise direction on the page.

A comparative example is for calculating the aberration reduction ratio with respect to a conventional art system and shows the parallel eccentricity of the second optical system 4B of the first variation example by 0 mm, that is, coaxial with the optical axis 4a.

The reflective display device 3 uses a 0.55 inch DMD having an aspect ratio of 4:3. That is, the image display region 3a has a width W of 11.2 mm and a height H of 8.4 mm. The axis offset Δh is 130%.

The focal distance of the variation examples is 16.4 mm, and the F number is 2.3.

Lens data having infinite object distance is shown below. The variables rᵢ and dᵢ (i is an integer) of FIG. 5 correspond to rᵢ and dᵢ as noted below. The unit of the length is the millimeter. The refractive index is with respect to d-line (wavelength of 587.56 mm).

| surface | | | | | |
|---|---|---|---|---|---|
| object | curvature radius ∞ | distance ∞ | eccentricity | refractive index | Abbe's number |
| 1 | r₁ = 44.054 | d₁ = 2.000 | α₁ | n₁ = 1.5163 | ν₁ = 64.1 |
| 2 | r₂ = 14.882 | d₂ = 5.168 | α₁ | | |
| 3 | r₃ = 58.054 | d₃ = 2.000 | | n₂ = 1.5163 | ν₂ = 64.1 |
| 4 | r₄ = 20.547 | d₄ = 9.075 | | | |
| 5 | r₅ = 226.227 | d₅ = 3.000 | | n₃ = 1.8052 | ν₃ = 25.4 |
| 6 | r₆ = −31.665 | d₆ = 2.766 | | | |
| 7 | r₇ = 16.829 | d₇ = 5.000 | | n₄ = 1.8061 | ν₄ = 40.9 |
| 8 | r₈ = −13.402 | d₈ = 2.000 | | n₅ = 1.6990 | ν₅ = 30.1 |
| 9 | r₉ = 25.399 | d₉ = 1.557 | | | |
| 10 | r₁₀ = −18.655 | d₁₀ = 1.750 | | n₆ = 1.8052 | ν₆ = 25.4 |
| 11 | r₁₁ = 21.401 | d₁₁ = 0.981 | | | |
| 12 | r₁₂ = −135.750 | d₁₂ = 3.500 | | n₇ = 1.6031 | ν₇ = 60.7 |
| 13 | r₁₃ = −16.139 | d₁₃ = 0.200 | | | |
| 14 | r₁₄ = 91.202 | d₁₄ = 3.500 | | n₈ = 1.6031 | ν₈ = 60.7 |
| 15 | r₁₅ = −22.576 | d₁₅ = 15.000 | | | |
| 16 | r₁₆ = 25.848 | d₁₆ = 6.500 | y₁, α₂ | n₉ = 1.7200 | ν₉ = 50.2 |
| 17 | r₁₇ = 3092.900 | d₁₇ = 2.500 | y₁, α₂ | | |
| 18 | r₁₈ = ∞ | d₁₈ = 3.000 | α₃ | n₁₀ = 1.4875 | ν₁₀ = 70.4 |
| 19 | r₁₉ = ∞ | d₁₉ = 0.500 | α₃ | | |
| image | ∞ | | α₃ | | |

Here, y1 denotes parallel eccentricity, and α1, α2, and α3 denote inclination eccentricity, and each variation example has the following values. Each direction is as described above (refer to arrows illustrated in FIG. 5).

| | y₁ (mm) | α₁ (degree) | α₂ (minute) | α₃ (degree) |
|---|---|---|---|---|
| variation example 1 | 0.3 | 0 | 0 | 0 |
| variation example 2 | 0.3 | 0 | 0 | 6 |
| variation example 3 | 0 | 0 | 1.5 | 0 |
| variation example 4 | 0 | 33 | 1.5 | 0 |
| comparative | 0 | 0 | 0 | 0 |
| example | | | | |

Next, the calculation of distortions and image surface curvature of the variation examples and of the comparative example are described.

The calculations are obtained from values on the image display region 3a by tracking inverse light beams.

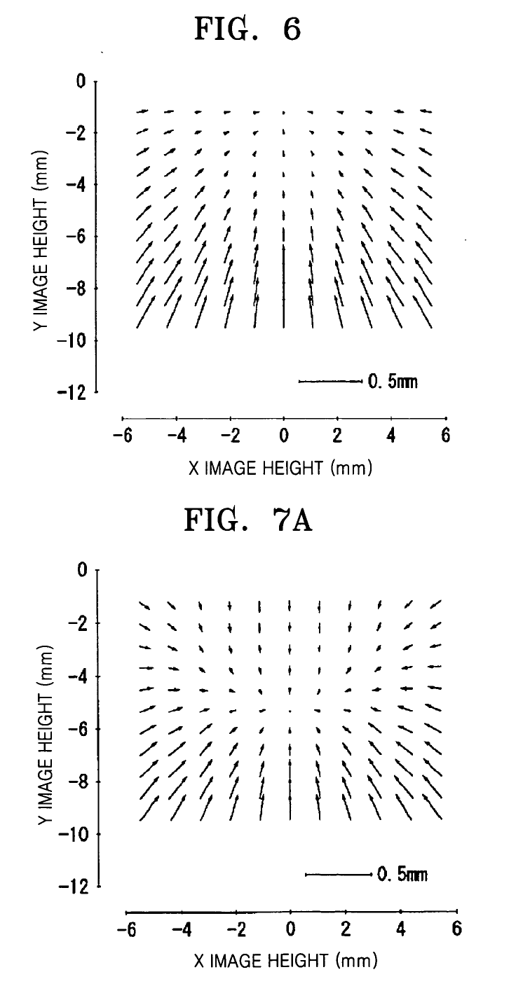

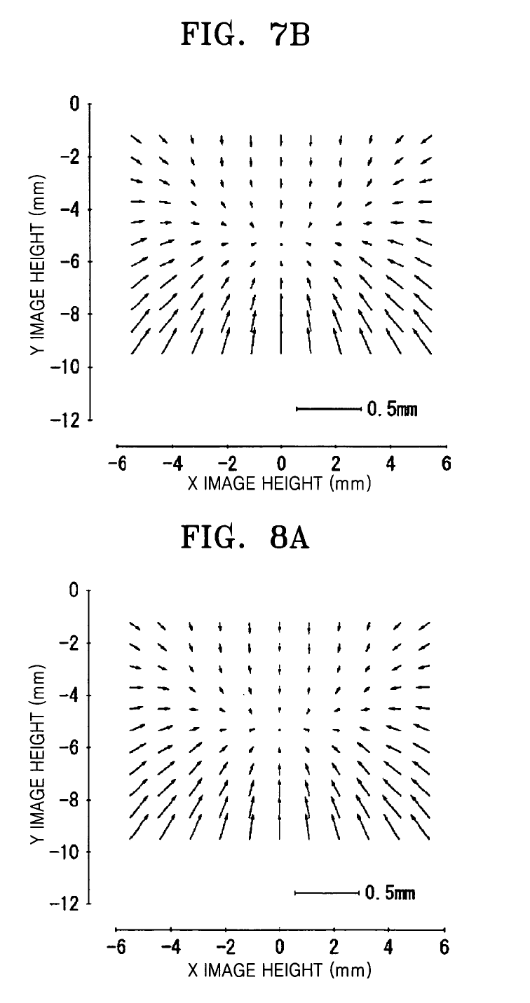

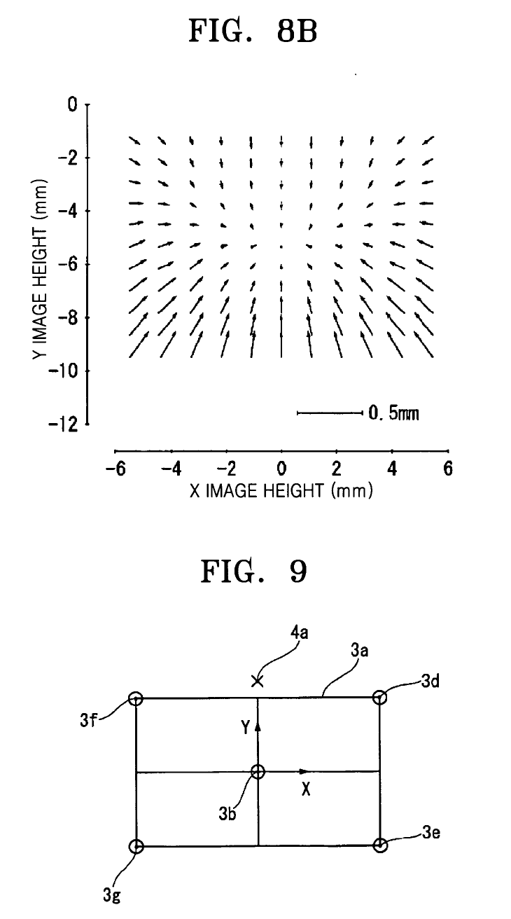

FIG. 6 is a vector diagram illustrating the distortion of the comparative example. The horizontal axis of the vector diagram illustrating the distortion indicates the image height in an x-direction (X image height) and the vertical axis indicates the image height in a y-direction (Y image height) in millimeters. The calculation position of the distortion is set to be the lattice point of the starting point of the arrow, and the direction of the distortion is expressed by the direction of the arrow, and the size of the distortion is expressed by the length of the arrow line with respect to the scale in the drawing, and this applies throughout the drawings hereinafter. FIGS. 7A and 7B are vector diagrams illustrating the distortion of the first and second variation examples, respectively. FIGS. 8A and 8B are vector diagrams illustrating the distortion of the third and fourth variation examples, respectively. FIG. 9 is a schematic view illustrating the calculation positions of the image surface curvature of the variation examples and of the comparative example.

The maximum of the distortion (Dmax) of each variation example and the improvement ratio (%) are shown in Table 1 below.

The improvement ratio is obtained by dividing the difference of Dmax of the comparative example and Dmax of each variation example by Dmax of the comparative example.

TABLE 1

| | | improvement |
|---|---|---|
| | Dₘₐₓ (mm) | ratio (%) |
| variation example 1 | 0.240 | 13.7 |
| variation example 2 | 0.244 | 12.2 |
| variation example 3 | 0.268 | 3.6 |
| variation example 4 | 0.280 | −0.7 |
| comparative example | 0.278 | 0 |

The calculation of the image surface curvature of each variation example is shown in Table 2 below.

TABLE 2

| | unit (mm) | | | | | | improvement |
|---|---|---|---|---|---|---|---|
| | C₊₊ | C₊₋ | C₀₀ | C₋₊ | C₋₋ | max–min | ratio (%) |
| variation example 1 | −0.0104 | −0.1590 | −0.0220 | −0.0104 | −0.1590 | 0.1486 | −6.8 |
| variation example 2 | −0.0083 | −0.1432 | −0.0130 | −0.0083 | −0.1432 | 0.1349 | 3.0 |
| variation example 3 | −0.0192 | −0.2658 | −0.0794 | −0.0192 | −0.2658 | 0.2466 | −77.0 |
| variation example 4 | −0.0099 | −0.1499 | −0.0406 | −0.0099 | −0.1499 | 0.1399 | −0.6 |
| comparative example | −0.0070 | −0.1459 | −0.0070 | −0.0070 | −0.1459 | 0.1391 | 0 |

Each image surface curvature C++, C+−, C−−, C−+, and C₀₀ denote each vertex and center in the image display region 3a, and correspond to, as illustrated in FIG. 9, a vertex 3d in a positive direction of X-axis and in a positive direction of Y-axis, a vertex 3e in positive axis of X-axis and in a negative direction of Y-axis, a vertex 3f in a negative direction of X-axis and in a positive direction of Y-axis, a vertex 3g in a negative direction of X-axis and in a negative direction of Y-axis, and a crossing center with a central normal 3b in millimeters.

The (max-min) column of Table 2 denotes the difference of the maximum and the minimum of the image surface curvature in the image display region 3a.

The improvement ratio is obtained by dividing the difference of the (max-min) of the comparative example and the (max-min) of each variation example by the (max-min) of the comparative example.

The distortion of the comparative example is the smallest in a positive direction of Y image height around the center of the X image height and increases in a negative direction of Y image height and in the area where the absolute value of X image height increases, as illustrated in FIG. 6. Thus irregular distortion is generated in upper and lower directions of the image projected, thereby deteriorating the image quality.

The curvature of the image surface of the comparative example is large at vertexes 3e and 3g as illustrated in FIG. 6. Thus, the image is out of focus around this area.

In the first variation example, the distortion becomes the smallest in the center of the image display region 3a as illustrated in FIG. 7A, thereby improving the symmetry of the amount of distortion in the upper and lower directions. Also, as illustrated in FIG. 1, Dmax is improved by 13.7%, compared to the comparative example.

Accordingly, distortion is significantly decreased due to the parallel eccentricity of the second optical system 4B in the direction in which the distortion occurs in the first variation example.

Meanwhile, according to Table 2, the curvature of the image surface of the first variation example is worsened overall, compared to that of the comparative example.

In the second variation example, the distortion has approximately the same tendency of the first variation example as illustrated in FIG. 7B, and Dmax of the second example is improved by 12.2% compared to that of the comparative example, as illustrated in Table 1.

Thus, even when the inclined eccentricity of the reflective display device 3 is added to the first variation example, like the second variation example, the distortion is significantly decreased as much as in the first variation example.

Meanwhile, according to Table 2, the curvature of the image surface has a value nearer to that of the comparative example than to that of the first variation example. Thus, the difference of the curvature of the image surface is improved by 3.0% compared to the comparative example.

Thus, the distortion is decreased and the curvature of the image surface is improved by combining the parallel eccentricity and the inclined eccentricity.

In the third variation example, the distortion has approximately the same tendency as the first variation example as illustrated in FIG. 8A, and Dmax of the third variation example is improved by 3.6% compared to that of the comparative example, as illustrated in FIG. 1.

Thus, the degree of decrease of the image distortion is relatively small but the symmetry of the image distortion is improved.

Meanwhile, according to Table 2, the curvature of the image surface is likely to be worsened compared to the comparative example.

In the fourth variation example, the distortion Dmax is −0.7%, almost the same as the comparative example as illustrated in FIG. 6, and the symmetry in upper and lower directions, as illustrated in FIG. 8B, is appropriate as in the first variation example. Thus, the symmetry of the image distortion is improved.

According to Table 2, the curvature of the image surface is significantly improved compared to the third variation example, and almost the same as the comparative example, −0.6%.

As is evident from these results, the second optical system 4B reduces distortion both in cases of parallel eccentricity and inclined eccentricity.

Also, the curvature of the image surface may be improved by increasing inclined eccentricity to the reflective display device 3 and some optical elements of the first optical system 4A.

Accordingly, by appropriately combining the parallel eccentricity or inclined eccentricity, the distortion may be decreased and the curvature of the image surface may be improved, thereby improving the image quality.

When the direction of eccentricity is reversed, the direction of the variation of aberration is also reversed, and thus the total aberration may be optimized by changing the direction of the optical devices when necessary.

According to the projection optical system and the projection display device of exemplary embodiments of the present invention, the aberration in the area where the image display region is projected offset may be reduced by the second optical system being eccentric, which is disposed near the display device. Thus, the aberration may be reduced using a simple structure to project high quality images.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A projection optical system, comprising:
a display device for displaying an image to be projected onto an image display region; and
first and second optical systems sequentially disposed along an optical path from a screen to the display device; wherein when the optical axis of the first optical system is a reference axis, the image display region of the display device is disposed with parallel eccentricity to the reference axis, and the second optical system is disposed eccentrically to the reference axis so that an image displayed on the image display region is enlarged and projected to a position that is eccentric with reference to the reference axis.

2. The projection optical system of claim 1, wherein the second optical system is disposed nearest to the display device as an optical device having refractive power.

3. The projection optical system of claim 1, wherein the second optical system is disposed with parallel eccentricity to the reference axis.

4. The projection optical system of claim 1, wherein the second optical system is disposed with inclined eccentricity to the reference axis.

5. The projection optical system of claim 1, wherein the first optical system is formed of a plurality of optical elements.

6. The projection optical system of claim 5, wherein at least one of the plurality of optical elements of the first optical system is disposed with parallel eccentricity or inclined eccentricity to the reference axis.

7. The projection optical system of claim 1, wherein the image display region of the display device is disposed with inclined eccentricity to the reference axis.

8. The projection optical system of claim 5, wherein the image display region of the display device is disposed with inclined eccentricity to the reference axis.

9. An projection display device, comprising:
an illuminating unit for illuminating light to form an image to be projected;
a display device for displaying an image to be projected onto an image display region; and
first and second optical systems sequentially disposed along an optical path from a screen to the display device;
wherein when the optical axis of the first optical system is a reference axis, the image display region of the display device is disposed with parallel eccentricity to the reference axis, and the second optical system is disposed eccentrically to the reference axis so that an image displayed on the image display region is enlarged and projected to a position that is eccentric with reference to the reference axis.

10. The projection display device of claim 9, wherein the image display region of the display device is disposed with inclined eccentricity to the reference axis.

11. The projection display device of claim 9, wherein the display device is a reflective display device.

12. The projection display device of claim 11, wherein the illuminating unit is disposed to illuminate light to a front surface of the display device.

13. The projection display device of claim 9, wherein the display device is a transmissive display device.

14. The projection display device of claim 13, where in the illuminating unit is disposed to illuminate light to a rear surface of the display device.
